(19) United States
(12) Patent Application Publication
(10) Pub. No.: US 2014/0079876 A1
(43) Pub. Date: Mar. 20, 2014

(54) STRUCTURE MANUFACTURING METHOD

(71) Applicants: Tomofumi Katayama, Osaka-shi (JP); Takashi Kakinoki, Osaka-shi (JP)

(72) Inventors: Tomofumi Katayama, Osaka-shi (JP); Takashi Kakinoki, Osaka-shi (JP)

(73) Assignee: SHARP KABUSHIKI KAISHA, Osaka-shi, Osaka (JP)

(21) Appl. No.: 14/123,015

(22) PCT Filed: Jul. 27, 2012
(86) PCT No.: PCT/JP2012/069253

§ 371 Date: Nov. 27, 2013

(30) Foreign Application Priority Data
Aug. 12, 2011 (JP) 2011-177319

(51) Int. Cl. H01Q 1/38

(52) U.S. Cl. CPC H01Q 1/38
USPC 427/98.6; 264/272.15

(57) ABSTRACT

A structure (10) including (i) a casing (1) made of a dielectric and (ii) a conducting member (2) embedded in the casing (1) so as to be through the casing (1) is manufactured by insert molding. The conducting member (2) is provided with a recess (2c), and an upper mold (40) is provided with a protrusion (40a) corresponding to the recess (2c). The conducting member (2) is positioned to be fixed in the mold by fitting the protrusion (40a) in the recess (2c).

### TECHNICAL FIELD

The present invention relates to a method for manufacturing a structure which includes (i) a casing made of a dielectric and (ii) a conducting member embedded in the casing so as to be through the casing, the method being used for, for example, a casing of a mobile phone.

### BACKGROUND ART

Recent electronic devices such as a mobile phone have been required to be highly functional while being small. Accordingly, components of such electronic devices are also required to be highly accurate and highly functional. A known method for preparing such highly accurate and highly functional components is exemplified by insert molding. Insert molding is a method for integrally molding a conducting member and a resin by inserting the conducting member into a mold and filling, with a molten resin, a portion around the conducting member inside the mold, and then solidifying the molten resin.

A method for manufacturing a component by insert molding is exemplified by a method disclosed in Patent

A method for manufacturing a component by insert molding is exemplified by a method disclosed in Patent Literature 1 for manufacturing a component for a pressure switch. The component for a pressure switch which component is disclosed in Patent Literature 1 is molded so that a connection terminal made of a metal plate is embedded in a resin terminal base.

According to the method for manufacturing a component for a pressure switch, a standing part 201 of the connection terminal 200 is inserted into a recess of an upper mold 220, whereas a part of the connection terminal 200 which part is on an opposite side of the standing part 201 is arranged so as to be pressed against a lower mold 221 (see FIG. 8). In this state, in a case where the molds are filled with a resin and the resin is solidified, it is possible to obtain a component for a pressure switch in which component the connection terminal 200 and the terminal base are integrally molded.

### CITATION LIST

### Patent Literature

Patent Literature 1

Japanese Patent Application Publication, Tokukai, No. 2006-185599 A (Publication Date: Jul. 13, 2006)

### SUMMARY OF INVENTION

### Technical Problem

According to the component for a pressure switch which component is disclosed in Patent Literature 1, the standing part 201 of the connection terminal 200 is used to fix the connection terminal 200 in the mold. Note here that the standing part 201, which is a member protruding from a terminal base 210, can be used to fix the connection terminal 200 in the mold. However, the method described in Patent Literature 1 causes problems (i) such that it is impossible to fix, in a mold, a metallic component having no part that protrudes from a resin part and (ii) such that a terminal cannot have a flat surface due to a member provided to protrude on the terminal side, so that a contact surface of the terminal is small.

The present invention has been made in view of the problems, and an object of the present invention is to provide a manufacturing method which makes it possible to (i) manufacture, by insert molding, a structure including a metallic component having no part that protrudes from a resin part and (ii) sufficiently secure a contact surface of the structure.

### Solution to Problem

In order to attain the object, the present invention is a method for manufacturing a structure which includes (i) a casing made of a dielectric and (ii) a conducting member embedded in the casing so as to be through the casing, the method including: a first step of fixing a conducting member in a mold; and a second step of forming the casing by filling the mold with a dielectric material and solidifying the dielectric material, the conducting member being provided with a recess, and the mold being provided with a protrusion corresponding to the recess, and in the first step, the conducting member being fixed in the mold by fitting the protrusion of the mold in the recess of the conducting member.

According to the configuration, the conducting member is provided with the recess, and the mold is provided with the protrusion corresponding to the recess. In the first step, the conducting member is fixed in the mold by fitting the protrusion of the mold in the recess of the conducting member. According to this, the conducting member, which has no protrusion that protrudes from the casing, can also be fixed in the mold and manufactured by insert molding. In other words, since a structure manufactured by the method for manufacturing a structure of the present embodiment has no protrusion that protrudes from the casing, a thickness of the structure itself can be made thin.

Furthermore, a second surface of the conducting member which second surface is opposite from a first surface of the conducting member of the structure on which first surface the recess is provided is not involved in fixing of the conducting member. This allows the second surface to be flat, so that the conducting member can have a sufficiently secured surface of a contact with another circuit.

### ADVANTAGEOUS EFFECTS OF INVENTION

The present invention is a method for manufacturing a structure which includes (i) a casing made of a dielectric and (ii) a conducting member embedded in the casing so as to be through the casing, the method comprising: a first step of fixing a conducting member in a mold; and a second step of forming the casing by filling the mold with a dielectric material and solidifying the dielectric material, the conducting member being provided with a recess, and the mold being provided with a protrusion corresponding to the recess, and in the first step, the conducting member being fixed in the mold by fitting the protrusion of the mold in the recess of the conducting member. This yields an effect such that the conducting member, which has no protrusion that protrudes from the casing, can also be fixed in the mold and manufactured by insert molding.

### BRIEF DESCRIPTION OF DRAWINGS

(a) through (c) of FIG. 1 show how to manufacture a structure of an embodiment of the present invention.

FIG. 2 is a cross-sectional view schematically illustrating a configuration of a structure of an embodiment of the present invention.

FIG. 3 is a perspective cross-sectional view schematically illustrating a configuration of a communication device including a structure of an embodiment of the present invention.

FIG. 4 is a cross-sectional view illustrating a modified example of a structure of an embodiment of the present invention.

FIG. 5 is a cross-sectional view illustrating a further modified example of a structure of an embodiment of the present invention.

(a) through (d) of FIG. 6 show an example of a process for forming a conducting pattern of a structure of an embodiment of the present invention.

FIG. 7 illustrates another configuration for providing a function equivalent to that of a structure of the present invention.

FIG. 8 shows how to manufacture a conventional structure.

### DESCRIPTION OF EMBODIMENTS

(Structure)

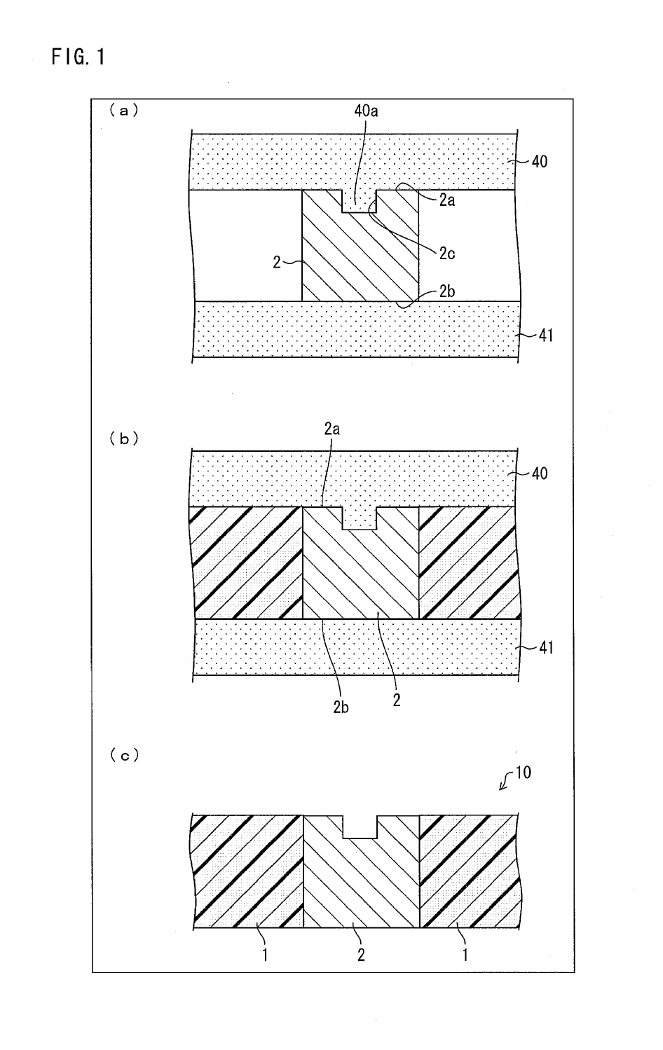

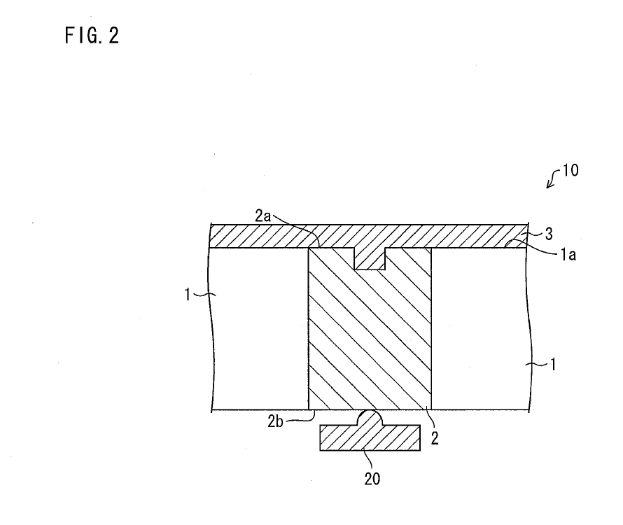

The following will first discuss a structure which is manufactured in accordance with a manufacturing method of an embodiment of the present invention. FIG. 2 is a cross-sectional view schematically illustrating a structure of an embodiment of the present invention. A structure 10 of the present embodiment includes a casing 1 and a conducting member 2 (see FIG. 2). Furthermore, one surface of the structure 10 may be provided with a conducting pattern 3 which is electrically connected with the conducting member 2.

The casing 1 is made of a dielectric and constitutes a casing of an electronic device. The casing of the electronic device refers to a member in which an electronic component of the electronic device is stored. The conducting member 2, which is a conducting material that is embedded in the casing 1 so as to be through the casing 1, electrically connects regions between which the casing 1 is provided (e.g., an upper side of the casing 1 shown in FIG. 1 (hereinafter, the upper side is also referred to as an outside of the casing 1)) and a lower side of the casing 1 (hereinafter, the lower side is also referred to as an inside of the casing 1). The casing 1 can be configured to be made of, for example, a resin, but is not limited to this. Further, the conducting member 2 can be configured to be made of, for example, a metal, but is not limited to this. The conducting member 2 is fixed to the casing 1 by being integrally molded with the casing 1.

It is assumed in the following description that the structure 10 has a first surface corresponding to an outer surface of the casing 1 and a second surface corresponding to an inner surface of the casing 1. It is also assumed that the casing 1 has a surface 1a corresponding to the first surface and a surface 1b corresponding to the second surface. The conducting member 2, which is through the casing 1, has exposed surfaces on the respective first and second surfaces. It is assumed that the exposed surface on the first surface of the conducting member 2 is a surface 2a and the exposed surface on the second surface of the conducting member 2 is a surface 2b.

The conducting pattern 3 is a conducting film which is provided on the first surface of the structure 10 so as to be in contact with the conducting member 2. The conducting pattern 3 is a conducting film which has no shape retention in itself (has no self shape retention). For example, the conducting pattern 3 can be a flexible conducting film such as a flexible printed circuit board or a conducting film formed by applying conducting paste.

Conducting paste, which is a viscous conducting material, at least contains metal powder and a solvent, and preferably contains metal powder, a binder resin, and a solvent. For example, according to a conducting film formed by applying conducting paste, a solvent may be removed by drying from the conducting film, or a part of the solvent may remain in the conducting film.

It is possible to employ various methods for applying conducting paste. However, conducting paste is preferably applied by printing by use of a flexible printing plate (e.g., flexsographic printing, offset printing, silk-screen printing, pad printing, or the like) so as to be suited to shapes of the casing 1 and the conducting member 2.

The surface 2b of the conducting member 2 which surface 2b is opposite from the surface 2a on which the conducting pattern 3 is provided is in electrical contact with a terminal (e.g., a spring terminal 20) provided in the casing 1. The conducting pattern 3 is in electrical contact with another member via the conducting member 2 and the spring terminal 20.

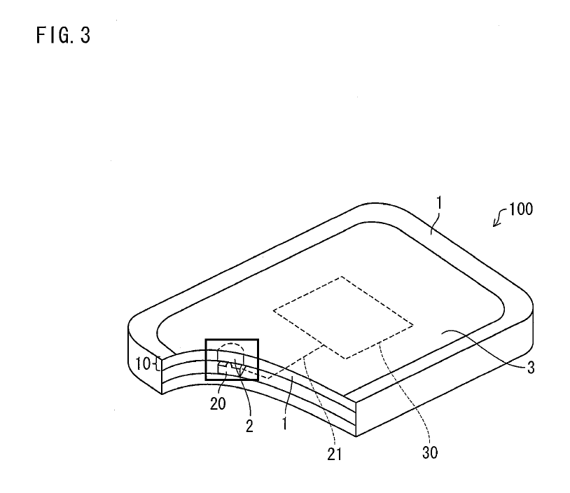

The structure 10 thus configured can be embedded in, for example, a communication device. FIG. 3 is a cross-sectional view schematically illustrating a configuration of a communication device 100 including the structure 10, to which a part enclosed by a thick line in FIG. 3 corresponds. The communication device 100 can be, for example, a tablet communication device (e.g., a smart phone, an electronic book, a tablet PC, or the like). However, the communication device 100 does not need to be such a tablet communication device provided that the communication device 100 includes a casing and has at least one of a function of receiving information from another device and a function of transmitting information to another device.

The casing 1 is a casing of the communication device 100 (see FIG. 3). The conducting pattern 3 is provided on a surface of the casing 1. Note that it is only necessary that a part of the casing 1 which part is in contact with each of the conducting member 2 and the conducting pattern 3 be made of a dielectric. Therefore, all parts of the casing 1 do not need to be made of a dielectric (In other words, a part of the casing 1 which part is made of a material other than a dielectric is excluded from the structure 10).

The spring terminal 20 is connected via a feed line 21 with the communication circuit 30 of the communication device 100. According to the communication device 100, the conducting pattern 3, which is fed by the communication circuit 30 via the feed line 21, the spring terminal 20, and the conducting member 2, operates as an antenna. In this case, the surface 2b of the conducting member 2 serves as an electrode to be connected with the feed line 21 via which the conducting pattern 3 is fed.

Note that the casing 1 and the conducting pattern 3 do not necessarily need to be exposed on a surface of the communication device 100 but may also be stored in the communication device 100. Note also that the conducting pattern 3 does not necessarily need to function as an antenna but may also function as a conducting member which allows a member connected with the spring terminal 20 to be electrically connected via the conducting pattern 3 to a member provided on the outside of the casing 1.

The conducting member 2 can be, for example, columnar, and preferably pin-shaped. Note that a pin shape refers to a shape such that a length in a direction in which the conducting member 2 is through the casing is longer than a width in a direction perpendicular to the direction in which the conducting member 2 is through the casing. Note that the conducting member 2 may have not only a cylindrical shape but also a prism shape. Further, the conducting member 2 does not need have a uniform thickness.

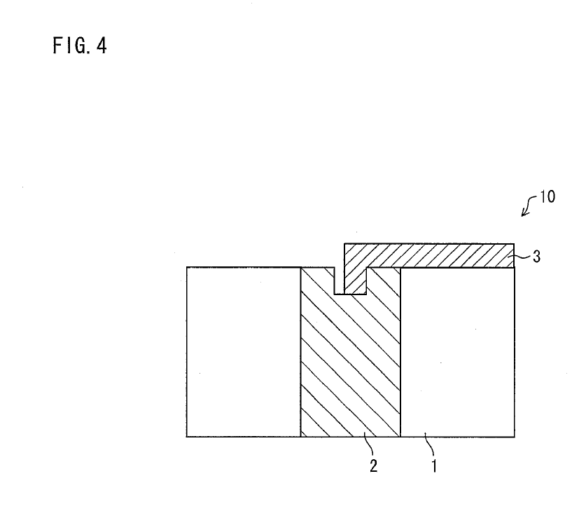

Furthermore, the conducting pattern 3 is not particularly limited in shape. It is possible to appropriately set a shape of the conducting pattern 3 in accordance with, for example, design of the structure 10 and the communication device 100. For example, the conducting pattern 3 may have a shape which covers only a part of the surface 2a of the conducting member 2 (see FIG. 4).

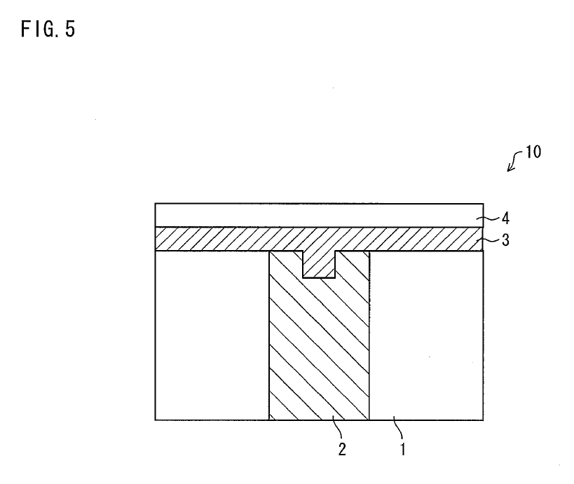

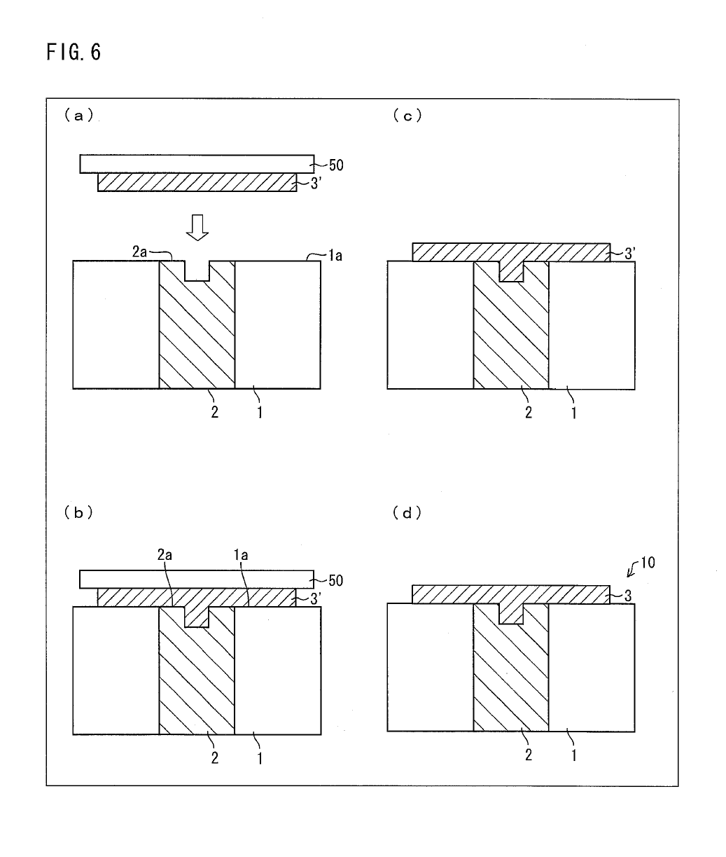

According to an embodiment of the present invention, the communication device 100 may further include a protective layer 4 provided on the conducting pattern 3 (see FIG. 5). In a case where the communication device 100 further includes the protective layer 4 provided on the conducting pattern 3, it is possible to prevent the conducting pattern 3 from being damaged. Note that it is only necessary that the protective layer 4 (i) be made of a material which does not affect antenna performance and (ii) be strong enough to protect the conducting pattern 3. Note here that “does not affect antenna performance” means that antenna performance does not greatly deteriorate depending on presence of the protective layer 4. For example, a protective layer made of a coating agent (e.g., a resin solution) can be suitably used as the protective layer 4. Application of the coating agent may also serve as coating of the casing 1. Further, it is also possible to suitably use, as the protective layer of the conducting pattern 3, a method for attaching, to the conducting pattern 3, a sheet made of, for example, a PET material, or pressing the sheet on the conducting pattern 3 by heat or pressure. Further, this allows the conducting pattern to be covered.

(Method for Manufacturing Structure)

The method for manufacturing the structure 10 is described with reference to (a) through (c) of FIG. 1. The structure 10 is basically manufactured by insert molding. That is, the casing 1 is obtained by filling a mold with a dielectric material (resin) and solidifying the dielectric material. In this case, the structure 10 in which the conducting member 2 is embedded in the casing 1 can be obtained by fixing the conducting member 2 in the mold in advance and filling a portion around the conducting member 2 inside the casing 1 with the dielectric material.

The mold is constituted by an upper mold 40 and a lower mold 41. The conducting member 2 has a recess 2c on the surface 2a which is in contact with the upper mold 40. The upper mold 40 has a protrusion 40a.

In a case where the protrusion 40a of the upper mold 40 is fitted in the recess 2c of the conducting member 2, the conducting member 2 is positioned to be fixed in the mold (see (a) of FIG. 1). In this case, the surface 2a of the conducting member 2 is in contact with a lower surface of the upper mold 40, and the surface 2b of the conducting member 2 is in contact with an upper surface of the lower mold 41.

After the conducting member 2 has been positioned to be fixed in the mold, the dielectric material is filled via a filling hole (not illustrated) into the mold (see (b) of FIG. 1). In this case, the dielectric material is filled so as to wrap around the conducting member 2 without being in contact with the surfaces 2a and 2b of the conducting member 2.

After the dielectric material filled in the mold has been solidified to be the casing 1, the upper mold 40 and the lower mold 41 are removed, so that the structure 10 is obtained (see (c) of FIG. 1). According to the structure 10, the surfaces 2a and 2b of the conducting member 2 are exposed. That is, the conducting member 2 is through the casing 1.

For example, the conducting pattern 3 may be formed by, for example, applying conducting paste to the surface 1a and the surface 2a so that a desired pattern is formed, and then subjecting the conducting paste to, for example, drying. It is possible to employ various methods for applying conducting paste. However, conducting paste is preferably applied by printing by use of a flexible printing plate (e.g., flexsographic printing, offset printing, silk-screen printing, pad printing, or the like) so as to be suited to shapes of the casing 1 and the conducting member 2.

FIG. 6 shows an example of a process in which the conducting pattern 3 is formed. First, a printing plate 50 having a surface on which a desired pattern is formed in advance by use of conducting paste 3′ is made closer to surfaces (the surfaces 1a and 2a) on an identical side of the casing 1 and the conducting member 2, respectively, which are formed in a first step (see (a) of FIG. 6). Then, the printing plate 50 is pressed against the surfaces 1a and 2a (see (b) of FIG. 6), so that a pattern of the conducting paste 3′ is transferred onto the surfaces 1a and 2a (see (c) of FIG. 6). Then, the conducting pattern 3 can be formed by drying the pattern of the conducting paste 3′ (see (d) of FIG. 6). Note that it is possible to use a silk-screen printing method in which the conducting paste 3′ is pressed out of a hole provided in the printing plate 50.

Further, the conducting pattern 3 which is constituted by a flexible printed circuit board can be formed by attaching the flexible printed circuit board to the surfaces 1a and 2a so that the flexible printed circuit is in contact with the conducting member 2.

Note that, in a case where the structure 10 including the protective layer 4 is formed (see FIG. 5), the protective layer 4 can be easily formed by applying, after a second step, the coating agent (e.g., the resin solution) to the conducting pattern 3 and then drying the coating agent. Alternatively, the protective layer can also be formed by attaching, to the conducting pattern 3, a sheet made of, for example, a PET material, or pressing the sheet on the conducting pattern 3 by heat or pressure.

(Advantage of Present Embodiment)

The structure 10 of the present embodiment makes it possible to electrically connect the regions between which the casing 1 is provided. Further, according to an embodiment of the present invention, the conducting pattern 3 may be provided. The conducting pattern 3 may be used as an antenna, or may be used to be electrically connected with a member provided in a region in which the conducting pattern 3 is provided. Note here that according to an embodiment of the present invention, the conducting pattern 3 is a conducting film which has no shape retention in itself.

Therefore, the conducting pattern 3 can be fixed in a free shape. This brings about an advantage of increasing a degree of freedom of design.

According to an embodiment of the present invention, the conducting pattern 3 can be formed by application of the conducting paste. This allows the conducting pattern to be thin and easily allows the conducting pattern to have a curved surface shape. This allows a further increase in degree of freedom of design.

According to an embodiment of the present invention, the conducting paste can be applied by printing by use of a flexible printing plate (e.g., flexsographic printing, offset printing, silk-screen printing, pad printing, or the like). Therefore, the conducting pattern can be successfully printed in accordance with, for example, a shape of the casing. This contributes to, for example, mass production of a structure.

According to an embodiment of the present invention, the conducting pattern 3 can be constituted by a flexible conducting film such as a flexible printed circuit board. This also allows the conducting pattern 3 to be fixed in a free shape. Therefore, the degree of freedom of design can be increased.

According to the method for manufacturing the structure 10 of the present embodiment, the conducting member 2 is provided with the recess 2c, and the upper mold 40 is provided with the protrusion 40a corresponding to the recess 2c. Further, the conducting member 2 can be positioned to be fixed in the mold by fitting the protrusion 40a of the upper mold 40 in the recess 2c of the conducting member 2. According to this, the conducting member 2, which has no protrusion that protrudes from the casing, can also be fixed in the mold, so that the casing 1 can be manufactured by insert molding. In other words, since the structure 10 manufactured by the method for manufacturing the structure 10 of the present embodiment has no protrusion that protrudes from the casing 1, the structure 10 can be made thin.

Furthermore, in the case of the conventional technique in which the conducting member 2 has a protrusion for fixing the conducting member 2 in the mold, a disconnection of the conducting pattern 3 may occur around the protrusion. However, according to the present embodiment, the conducting member 2 has no protrusion for fixing the conducting member 2 in the mold. Therefore, the conducting pattern 3 which is electrically connected with the conducting member 2 can be easily formed in the structure 10 manufactured by the method of the present embodiment. Moreover, the surface 2b of the conducting member 2, which surface 2b is not involved in fixing of the conducting member 2, can be flat, so that the conducting member 2 can have a sufficiently secured surface of a contact with the spring terminal 20.

According to an embodiment of the present invention, the conducting pattern 3 is provided after fixing the casing 1 and the conducting member 2. Therefore, even if the conducting pattern 3 is constituted by a conducting film having no shape retention in itself (e.g., a conducting paste is a flexible printed circuit board), the conducting pattern 3 can be provided on the casing 1 and the conducting member 2 (the surface 1a and the surface 2a) with no difficulty.

According to the structure 10 of an embodiment of the present invention, since the conducting member 2 is made columnar, the conducting member 2 which is through the casing 1 can be suitably provided.

According to the structure 10 of an embodiment of the present invention, since the casing 1 and the conducting member 2 are integrally molded, the conducting member 2 can be preferably embedded in the casing 1.

According to an embodiment of the present invention, since the casing 1 is a casing of a communication device and the conducting pattern 3 is an antenna, the communication device having a higher degree of freedom of design of the antenna can be provided by using the conducting pattern as the antenna.

According to an embodiment of the present invention, since the surface 2b is used as an electrode to be connected with a feed line 21 via which the conducting pattern 3 is fed, it is possible to feed the conducting pattern 3 via the feed line 21 provided in the regions between which the casing 1 is provided. This makes it possible to provide the communication device having a higher degree of freedom of design of the antenna.

According to an embodiment of the present invention, since the protective layer 4 is formed on the conducting pattern 3, the conducting pattern 3 can have higher durability.

[Comparison with Other Configurations]

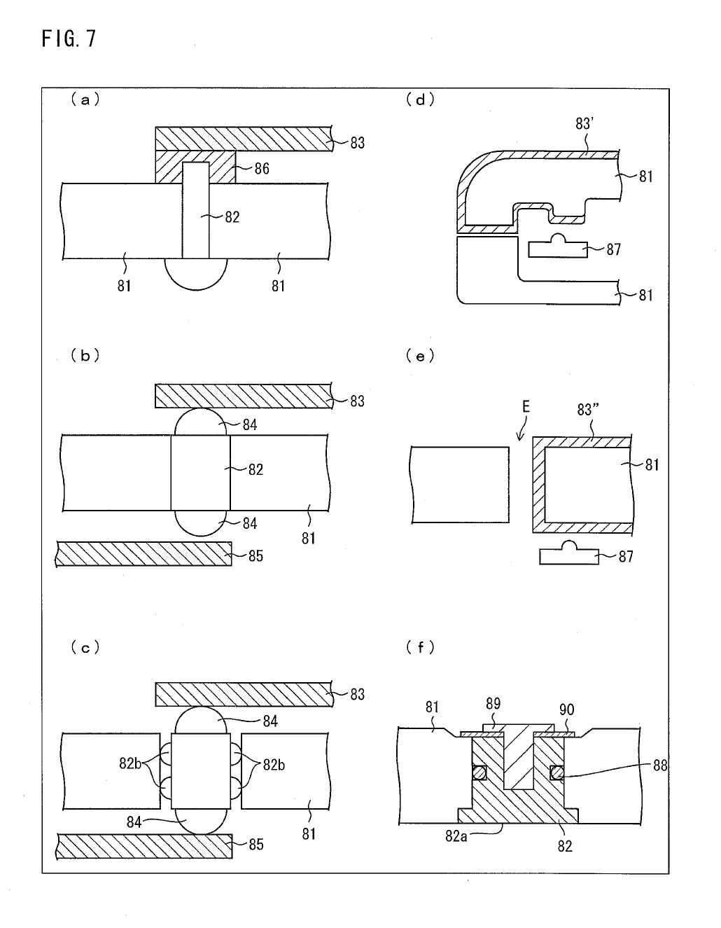

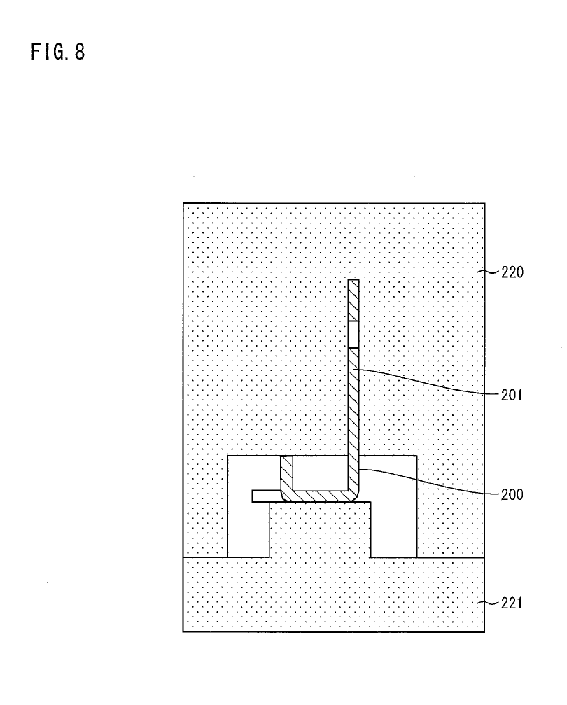

FIG. 7 illustrates other configurations studied by the inventors of the present invention so as to provide functions equivalent to that of the structure 10.

(a) of FIG. 7 illustrates a configuration in which a conducting pin 82 protrudes by being through a resin part and a protruding part thereof adheres to a metal plate 83 via an adhesive 86 which is electrically conductive. According to the configuration, the adhesive 86 needs to have (i) a thickness for covering the protruding part and (ii) a volume for obtaining a strength for fixing the resin part 81 and the metal plate 83. This causes a problem of difficulty in slimming down.

(b) of FIG. 7 illustrates a configuration in which the conducting pin 82 which is embedded in the resin part 81 is connected via a pogo pin 84 with each of the metal plate 83 and a metal plate 85 (the conducting pin 82 may be connected with the metal plate 85 via a protrusion instead of the pogo pin). According to the configuration, the metal plate 83 needs to be thick so as to have stiffness which prevents the metal plate 83 from being bent by the pogo pin 84. This causes a problem of difficulty in slimming down.

(c) of FIG. 7 and (b) of FIG. 7 are substantially identical in configuration but differ in that the conducting pin 82 has protrusions 82b on side surfaces thereof so as to compress the protrusions 82b into the resin part 81. The configuration illustrated in (c) of FIG. 7 has not only a problem identical to that of the configuration illustrated in (b) of FIG. 7 but also a problem such that waterproofness is lost in a space between the resin part 81 and the conducting pin 82.

(d) of FIG. 7 illustrates a configuration in which a conducting section 83′ is led from an outside via a side surface to an inside of the resin part 81 so as to be connected with a spring terminal 87. According to the configuration, in a case where the conducting section 83′ is formed by printing or an LDS (Laser Direct Structure), the conducting section 83′ and the spring terminal 87 are easily disconnected from each other in a folded part of the conducting section 83′. Meanwhile, in a case where the conducting section 83′ is formed by an MID (Molded Interconnect Device), waterproofness is lost in a part of the conducting section 83′ in which part the conducting section 83′ is led into the casing. Further, a fitting part of the resin part 81 generally has a complicated structure. This may cause the conducting section 83′ to have a complicated shape or may prevent the conducting section 83′ from being provided. Even if the conducting section 83′ can be provided, the conducting section 83′ needs to be routed for a long distance. This may cause a deterioration in performance of the conducting section 83′ in a case where the conducting section 83′ is used as an antenna.

(e) of FIG. 7 illustrates a configuration in which the resin part 81 is provided with an opening E and a flexible printed circuit board 83″ is through the opening E. For example, the configuration have many restrictions on shape such as a restriction on a place at which a feeding point is provided in a case where the flexible printed circuit board 83″ is used as an antenna. Further, according to the configuration, waterproof performance is also impaired.

(f) of FIG. 7 illustrates a configuration in which the conducting pin 82 is embedded in the resin part 81, nut metal plates 90 are fixed by a screw 89 on the appearance side of the resin part 81, and for example, a spring mounted on a substrate is connected with an inside surface 82a of the conducting pin 82. Note that waterproof rings 88 may be provided between side walls of the resin part 81 and the conducting pin 82. Formation of the configuration requires tightening-together, caulking, or adhesion (a gasket, a conducting binding material, a conducting tape, or the like). Therefore, the nut metal plates 90 need to have a sufficient strength. This causes a deterioration in degree of freedom of shape of the nut metal plates 90.

As described earlier, the configuration of the structure 10 of the present embodiment yields a more advantageous effect than the configurations illustrated in (a) through (f) of FIG. 7.

[Additional Descriptions]

As described earlier, the present invention is a method for manufacturing a structure which includes (i) a casing made of a dielectric and (ii) a conducting member embedded in the casing so as to be through the casing, the method including: a first step of fixing a conducting member in a mold; and a second step of forming the casing by filling the mold with a dielectric material and solidifying the dielectric material, the conducting member being provided with a recess, and the mold being provided with a protrusion corresponding to the recess, and in the first step, the conducting member being fixed in the mold by fitting the protrusion of the mold in the recess of the conducting member.

According to the configuration, the conducting member is provided with a recess, and the mold is provided with a protrusion corresponding to the recess. In the first step, the conducting member is fixed in the mold by fitting the protrusion of the mold in the recess of the conducting member. According to this, the conducting member, which has no protrusion that protrudes from the casing, can also be fixed in the mold and manufactured by insert molding. In other words, since a structure manufactured by the method for manufacturing a structure of the present embodiment has no protrusion that protrudes from the casing, a thickness of the structure itself can be made thin.

Furthermore, a second surface of the conducting member which second surface is opposite from a first surface of the conducting member of the structure on which first surface the recess is provided is not involved in fixing of the conducting member. This allows the second surface to be flat, so that the conducting member can have a sufficiently secured surface of a contact with another circuit.

The method can be configured to further include: a third step, following the second step, of forming a conducting pattern so that the conducting pattern is electrically connected with the conducting member, the conducting pattern being provided on a first surface of the conducting member of the structure on which first surface the recess is provided.

In the case of the conventional technique in which the conducting member has a protrusion for fixing the conducting member in the mold, a disconnection of the conducting pattern may occur around the protrusion. However, according to the configuration, the conducting member has no protrusion for fixing the conducting member in the mold. Therefore, it is easy to carry out a process for, for example, forming, in the structure manufactured by the above method, a further conducting layer which is electrically connected with a surface of the conducting member.

The method can be configured such that in the third step, conducting paste is applied to the first surface of the conducting member of the structure on which first surface the recess is provided.

According to the configuration, the conducting pattern can be formed by application of the conducting paste. This allows the conducting pattern to be thin and easily allows the conducting pattern to have a curved surface shape. This allows a further increase in degree of freedom of design.

The method can be configured such that in the third step, the conducting paste is applied, by printing by use of a flexible printing plate, to the first surface of the conducting member of the structure on which first surface the recess is provided.

According to the configuration, the conducting material can be applied by printing by use of a flexible printing plate (e.g., flexsographic printing, offset printing, silk-screen printing, pad printing, or the like). Therefore, the conducting pattern can be successfully printed in accordance with, for example, a shape of the casing. This contributes to, for example, mass production of a structure.

The method can be configured such that: the casing is a casing of a communication device; and the conducting pattern is an antenna.

According to the configuration, the communication device having a higher degree of freedom of design of the antenna can be provided by using the conducting pattern as the antenna.

The method can be configured such that a second surface of the conducting member is electrically connected with another circuit, the second surface being opposite from the first surface of the conducting member on which first surface the recess is provided.

The method can be configured to further include a fourth step of forming a protective layer (attachment of a sheet material, coating with paint, or the like) on the conducting pattern.

According to the configuration, the conducting pattern can have higher durability. Further, the configuration allows the conducting pattern to be covered.

The method can be configured such that the conducting member is columnar.

According to the configuration, the conducting member which is through the casing can be suitably provided.

The present invention is not limited to the description of the embodiments described above, but may be altered within the scope of the claims. An embodiment based on a proper combination of technical means disclosed in different embodiments is encompassed in the technical scope of the present invention.

### INDUSTRIAL APPLICABILITY

The present invention is applicable to, for example, manufacture of a casing of an electronic device.

### REFERENCE SIGNS LIST

1 Casing
2 Conducting member
2c Recess
3 Conducting pattern
4 Protective layer
20 Spring terminal
30 Communication circuit
40 Upper mold
40a Protrusion
41 Lower mold
100 Communication device

1. A method for manufacturing a structure which includes (i) a casing made of a dielectric and (ii) a conducting member embedded in the casing so as to be through the casing, the method comprising:
a first step of fixing a conducting member in a mold; and
a second step of forming the casing by filling the mold with a dielectric material and solidifying the dielectric material,
the conducting member being provided with a recess, and the mold being provided with a protrusion corresponding to the recess, and
in the first step, the conducting member being fixed in the mold by fitting the protrusion of the mold in the recess of the conducting member.

2. The method as set forth in claim 1, further comprising:
a third step, following the second step, of forming a conducting pattern so that the conducting pattern is electrically connected with the conducting member, the conducting pattern being provided on a first surface of the conducting member of the structure on which first surface the recess is provided.

3. The method as set forth in claim 2, wherein in the third step, conducting paste is applied to the first surface of the conducting member of the structure on which first surface the recess is provided.

4. The method as set forth in claim 3, wherein in the third step, the conducting paste is applied, by printing by use of a flexible printing plate, to the first surface of the conducting member of the structure on which first surface the recess is provided.

5. The method as set forth in claim 2, wherein:
the casing is a casing of a communication device; and
the conducting pattern is an antenna.

6. The method as set forth in claim 2, wherein a second surface of the conducting member is electrically connected with another circuit, the second surface being opposite from the first surface of the conducting member on which first surface the recess is provided.

7. The method as set forth in claim 2, further comprising a fourth step of forming a protective layer on the conducting pattern.

8. The method as set forth in claim 1, wherein the conducting member is columnar.
